(19) United States
(12) Patent Application Publication
(10) Pub. No.: US 2025/0330570 A1
(43) Pub. Date: Oct. 23, 2025

(54) ADAPTIVE COST FUNCTION SELECTION IN MERGE MODE IN VIDEO CODING

(71) Applicant: QUALCOMM Incorporated, San Diego, CA (US)

(72) Inventors: Kai Cui, München (DE); Zhi Zhang, Munich (DE); Yan Zhang, San Diego, CA (US); Han Huang, San Diego, CA (US); Vadim Seregin, San Diego, CA (US); Marta Karczewicz, San Diego, CA (US)

(21) Appl. No.: 19/174,146

(22) Filed: Apr. 9, 2025

Related U.S. Application Data
(60) Provisional application No. 63/635,263, filed on Apr. 17, 2024.

(51) Int. Cl. H04N 19/105; H04N 19/159; H04N 19/176

(52) U.S. Cl. CPC H04N 19/105; H04N 19/159; H04N 19/176

(57) ABSTRACT

Example devices, methods, and computer readable media are described for adaptively selecting a cost function. An example device for decoding video data includes one or more memories configured to store the video data and one or more processors implemented in circuitry and operably coupled to the one or more memories. The one or more processors are configured to determine to decode a current block of the video data using an inter mode. The one or more processors are configured to determine a value of an index to a prediction candidate in a candidate list. The one or more processors are configured to determine the prediction candidate and a first cost function of a plurality of cost functions based on the value of the index. The one or more processors are configured to decode the current block based on the prediction candidate and the first cost function.

This application claims the benefit of U.S. Provisional Patent Application 63/635,263, filed Apr. 17, 2024, the entire contents of which is incorporated herein by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for inter prediction, decoder-side motion vector derivation techniques (e.g. template matching, bilateral matching, decoder-side motion vector (MV) refinement) and/or other techniques for video coding. More particularly, this disclosure describes techniques for adaptive selection of one or more cost functions. Many video coders and video coding standards use manually chosen cost functions for a particular coding tool or stage of a coding tool. For example, drafters of a particular video coding standard may mandate the use of a particular cost function for a particular coding tool or stage and implementers may implement such a particular cost function for the particular coding tool. However, the cost function mandated by the video standard may not always provide the highest coding efficiency and/or quality when compared to another cost function. Therefore, it may be desirable to provide for adaptive selection of a cost function, which may improve video coding efficiency and/or quality over a manually chosen cost function.

In one example, a method includes: determining to decode a current block of the video data using an inter mode; determining a value of an index to a prediction candidate in a candidate list; determining the prediction candidate and a first cost function of a plurality of cost functions based on the value of the index; and decoding the current block based on the prediction candidate and the first cost function.

In another example, a device includes one or more memories for storing video data and one or more processors operably coupled to the one or more memories, the one or more processors configured to: one or more memories configured to store the video data; and one or more processors implemented in circuitry and operably coupled to one or more memories, the one or more processors configured to: determine to decode a current block of the video data using an inter mode; determine a value of an index to a prediction candidate in a candidate list; determine the prediction candidate and a first cost function of a plurality of cost functions based on the value of the index; and decode the current block based on the prediction candidate and the first cost function.

In another example, a device includes: means for determining to decode a current block of the video data using an inter mode; means for determining a value of an index to a prediction candidate in a candidate list; means for determining the prediction candidate and a first cost function of a plurality of cost functions based on the value of the index; and means for decoding the current block based on the prediction candidate and the first cost function.

In another example, a method of encoding video data includes: determining to encode a current block of the video data using an inter mode; determining a value of an index to a prediction candidate in a candidate list; determining the prediction candidate and a first cost function of a plurality of cost functions based on the value of the index; and encoding the current block in accordance with the prediction candidate and the first cost function.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIGS. 2A-2B are conceptual diagrams illustrating example spatial neighboring MV candidates for merge and advanced motion vector prediction (AMVP) modes, respectively.

FIG. 3A is a conceptual diagram illustrating an example of a temporal motion vector predictor.

FIG. 3B is a conceptual diagram illustrating an example of motion vector scaling.

FIG. 4 is a conceptual diagram illustrating an example of MVD0 and MVD1 that are proportional based on temporal distances.

FIG. 5 is a conceptual diagram illustrating an example of MVD0 and MVD1 are mirrored regardless of the temporal distances.

FIG. 6 is a conceptual diagram illustrating an example of the 3×3 square search pattern in the search range [−8, 8].

FIG. 7 is a conceptual diagram illustrating an example of template matching performed on a search area around an initial MV.

FIG. 8 is a conceptual diagram illustrating an example of decoder-side motion vector refinement (DMVR).

FIG. 9 is a conceptual diagram illustrating example diamond regions in the search area.

FIG. 10 is a conceptual diagram illustrating example spatial neighboring blocks used to derive the spatial merge candidates.

FIG. 11 is a conceptual diagram illustrating example template and reference samples of the template in reference pictures.

FIG. 12 is a conceptual diagram illustrating example template and reference samples of the template for block with sub-block motion using the motion information of the subblocks of the current block.

FIG. 13A is a flowchart illustrating an example of adaptive cost function selection according to one or more aspects of this disclosure.

FIG. 13B is a flowchart illustrating another example of adaptive cost function selection according to one or more aspects of this disclosure.

FIG. 14 is a block diagram illustrating an example video encoder that may perform the techniques of this disclosure.

FIG. 15 is a block diagram illustrating an example video decoder that may perform the techniques of this disclosure.

FIG. 16 is a flowchart illustrating an example method for encoding a current block in accordance with the techniques of this disclosure.

FIG. 17 is a flowchart illustrating an example method for decoding a current block in accordance with the techniques of this disclosure.

### DETAILED DESCRIPTION

In some video coding standards, drafts, and implementations, different cost functions are primarily selected manually (e.g., pre-selected) for various coding tools, or in different coding stages, to quantify the cost of a coding tool. However, when applying the same cost function to refine the merge candidates, it is possible that different merge candidates may yield very similar refined results. This lack of diversity among merge candidates can potentially impact video coding performance, leading to sub-optimal refinement results, such as less efficient coding and/or lower decoded video quality.

This disclosure introduces techniques for adaptive selection of cost functions. For example, a video decoder may use a signaled candidate index (e.g., a merge index) for a current block, a block size of the current block, a prediction mode of the current block, and/or a separately signaled flag to determine a particular cost function, of a plurality of cost functions, to apply to the current block. By adaptively selecting cost functions, the techniques of this disclosure may increase merge candidate diversity and thereby improve video coding efficiency and/or quality.

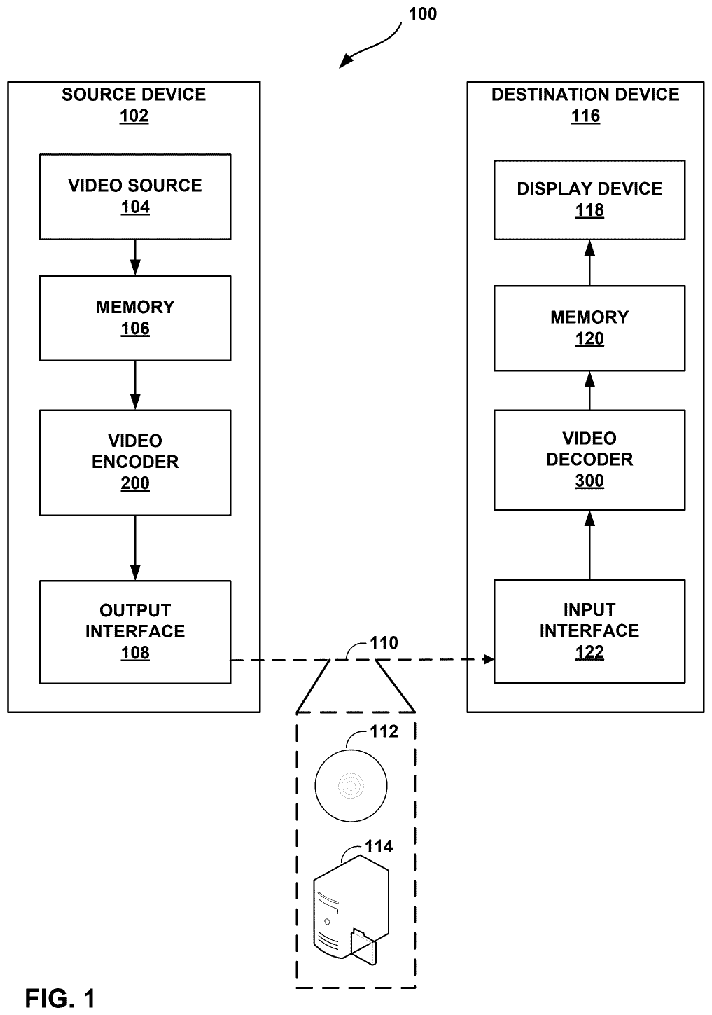

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for the adaptive selection of cost functions. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for the adaptive selection of cost functions. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (cMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, ILBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, Truc Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry that includes a processing system, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use the adaptive selection of cost functions techniques.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUs, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUS) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUS having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared errors (SSE), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, a method includes determining to decode a current block of the video data using an inter mode; determining a value of an index to a prediction candidate in a candidate list; determining the prediction candidate and a first cost function of a plurality of cost functions based on the value of the index; and decoding the current block based on the prediction candidate and the first cost function.

The techniques of this disclosure include inter prediction, decoder-side motion vector derivation techniques (e.g. template matching, bilateral matching, decoder-side MV refinement), and/or other techniques. These techniques may be applied to any existing video codecs, such as HEVC (High Efficiency Video Coding), VVC (Versatile Video Coding), Essential Video Coding (EVC) or be an efficient coding tool in future video coding standards. In the following section, HEVC, Joint Exploration Model (JEM) techniques and works in Versatile Video Coding (VVC) related to the techniques described herein are described.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, a new video coding standard, namely High Efficiency Video Coding (HEVC) or ITU-T H.265, including its range extension, multiview extension (MV-HEVC) and scalable extension (SHVC), has recently been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG).

The latest HEVC draft specification, and referred to as HEVC WD hereinafter, is available from phenix.int-evry.fr/jct/doc_end_user/documents/14_Vienna/wg11/JCTVC-N1003-v1.

ITU-T VCEG (Q6/16) and ISO/IEC MPEG (JTC 1/SC 29/WG 11) are studying the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. A version of reference software, e.g., VVC Test Model 10 (VTM 10.0) could be downloaded from: vcgit.hhi.fraunhofer.de/jvet/VVCSoftware_VTM

The Versatile Video Coding (VVC) draft specification could be referred to JVET-T2001. Algorithm description of Versatile Video Coding and Test Model 10 (VTM 10.0) could be referred to JVET-T2002.

CU structure and motion vector prediction in VVC is now described. In VVC, the largest coding unit in a slice is called a coding tree block (CTB) or coding tree unit (CTU). A CTB contains a quad-tree, binary-tree or ternary-tree, the nodes of which are coding units.

The size of a CTB can range from 4×4 to 128×128 in the VVC main profile. A coding unit (CU) could be the same size of a CTB to as small as 4×4. Each coding unit is coded with one mode, e.g., inter or intra. When a CU is inter-coded, the CU may be further partitioned into 2, 3 or 4 prediction units (PUs) or become just one PU when further partition does not apply. When two PUs are present in one CU, the two PUs are evenly divided to be half size rectangles. When three PUs are present in one CU, three rectangles of ¼, ½ and ¼ size of the CU are present.

When the CU is inter-coded, each PU has one set of motion information, which is derived with a unique inter prediction mode.

Motion vector prediction in VVC is now described. Video coders, such as video encoder 200 or video decoder 300, may implement VVC. In the VVC standard, there are two inter prediction modes, named merge (skip is considered as a special case of merge) and advanced motion vector prediction (AMVP) modes respectively for a prediction unit (PU).

In AMVP mode, a motion vector (MV) candidate list is maintained for multiple motion vector predictors. The motion vector(s), as well as reference indices in AMVP mode, of the current PU are generated by taking one candidate from the MV candidate list.

The MV candidate list contains up to two candidates for the AMVP mode. Under AMVP mode for each potential prediction direction from either list 0 or list 1, a reference index needs to be explicitly signaled (e.g., by a video encoder such as video encoder 200), together with an MV predictor (MVP) index to the MV candidate list since the AMVP candidate contains only a motion vector. In AMVP mode, the predicted motion vectors can be further refined.

The candidates for AMVP modes are derived from spatial neighboring blocks, temporal neighboring blocks, or a history-based motion information table.

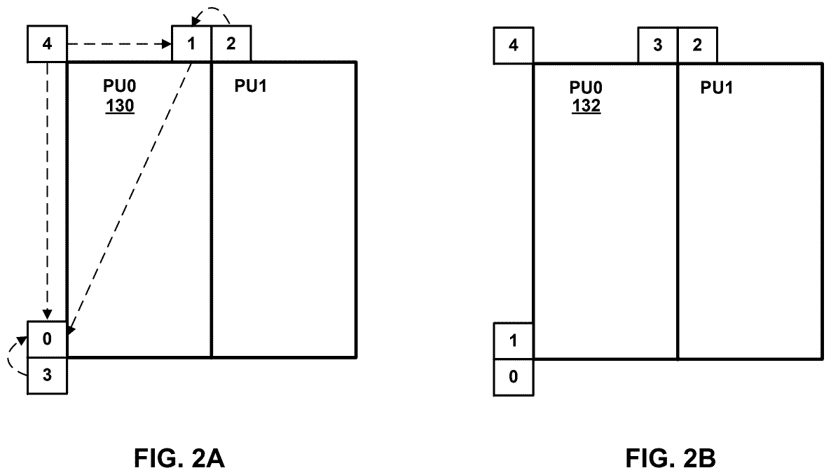

Spatial neighboring candidates are now described. FIGS. 2A-2B are conceptual diagrams illustrating example spatial neighboring MV candidates for merge and AMVP modes, respectively. For example, video encoder 200 or video decoder 300 may derive spatial MV candidates from neighboring blocks shown in FIGS. 2A-2B, for a specific PU (PU0), although the techniques video encoder 200 or video decoder 300 may use to generate the candidates from the blocks differ for merge and AMVP modes.

In merge mode, up to four spatial MV candidates for PU0 130 can be derived with the orders shown in FIG. 2A as follows: left (0, A1), above (1, B1), above right (2, B0), below left (3, A0), and above left (4, B2).

In AMVP mode, the neighboring blocks of PU0 132 are divided into two groups: left group including block 0 and 1, and above group including blocks 2, 3, and 4 as shown on FIG. 2B. For each group, the potential candidate in a neighboring block that refers to the same reference picture as that indicated by the signaled reference index has the highest priority to be chosen to form a final candidate of the group for PU0 132. It is possible that all neighboring blocks do not contain a motion vector pointing to the same reference picture. Therefore, if such a candidate cannot be found, the first available candidate will be scaled to form the final candidate, thus the temporal distance differences can be compensated. For example, video encoder 200 or video decoder 300 may select the first available candidate and scale that first available candidate to form a final candidate to compensate for temporal distance differences.

Temporal motion vector prediction in HEVC is now described. Video coders, such as video encoder 200 or video decoder 300 may implement HEVC. Temporal motion vector predictor (TMVP) candidate, if enabled and available, is added into the MV candidate list after spatial motion vector candidates. The process of motion vector derivation for TMVP candidate is the same for both merge and AMVP modes, however the target reference index for the TMVP candidate in the merge mode is always set to 0.

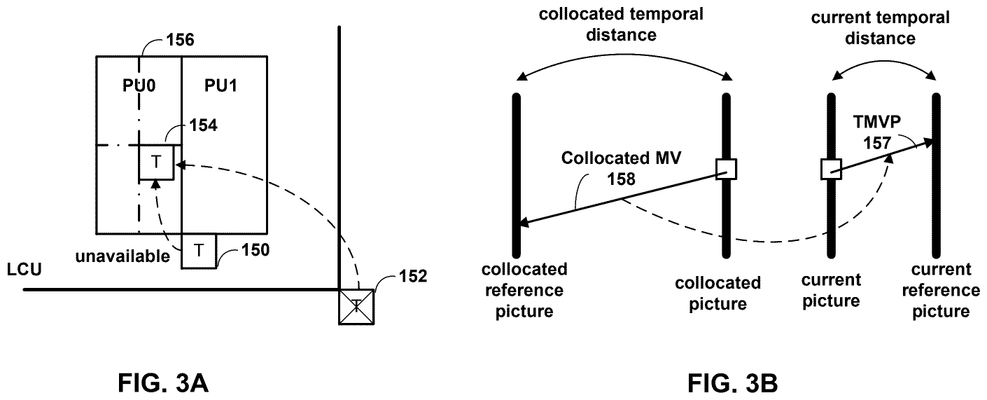

FIG. 3A is a conceptual diagram illustrating an example of a temporal motion vector predictor. FIG. 3A shows example TMVP candidates for block 156 (PU0) and FIG. 3B shows a motion vector scaling process. The primary block location for TMVP candidate derivation is the bottom right block outside of the collocated PU. This candidate is shown in FIG. 3A as a block “T” 154. The location of block T 154 is used to compensate the bias to the above and left blocks used to generate spatial neighboring candidates. However, if that block is located outside of the current CTB row (shown as block T 152), or motion information is not available (shown as block T 150), the block is substituted with a center block of the PU.

FIG. 3B is a conceptual diagram illustrating an example of motion vector scaling. Similar to temporal direct mode in AVC, to derive the TMVP candidate motion vector, the co-located MV may be scaled to compensate the temporal distance differences, as shown in FIG. 3B. Video encoder 200 and video decoder 300 may derive a motion vector for the TMVP candidate from the co-located PU of the co-located picture, indicated in the slice level. The motion vector for the co-located PU is called a collocated MV. Similar to temporal direct mode in AVC, to derive TMVP candidate motion vector 157, co-located MV 158 may be scaled to compensate the temporal distance differences, as shown in FIG. 3B.

Other aspects of motion prediction in HEVC are now described.

Several aspects of merge and AMVP modes are worth mentioning as follows.

Motion vector scaling: It is assumed that the value of motion vectors is proportional to the distance of pictures in the presentation time. A motion vector associates two pictures, the reference picture, and the picture containing the motion vector (namely the containing picture). When a motion vector is utilized to predict the other motion vector, the distance of the containing picture and the reference picture is calculated based on the Picture Order Count (POC) values.

For a motion vector to be predicted, both its associated containing picture and reference picture may be different. Therefore, a new distance (based on POC) is calculated. And the motion vector is scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Artificial motion vector candidate generation: If a motion vector candidate list is not complete, artificial motion vector candidates are generated and inserted at the end of the list until it will have all candidates.

In merge mode, there are two types of artificial MV candidates: combined candidate derived only for B-slices and zero candidates used only for AMVP if the first type does not provide enough artificial candidates.

For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

Pruning process for candidate insertion: Candidates from different blocks may happen to be the same, which decreases the efficiency of a merge/AMVP candidate list. A pruning process may be applied to solve this problem. The pruning process compares one candidate against the others in the current candidate list to avoid inserting identical candidate in certain extent. To reduce the complexity, only limited numbers of pruning process is applied instead of comparing each potential one with all the other existing ones.

Bilateral Matching Prediction is now discussed. Video encoder 200 and video decoder 300 may be configured to perform bilateral matching prediction. Bilateral Matching (also known as Bilateral Merge) (BM) prediction is another merge mode base on Frame-Rate Up Conversion (FRUC) techniques. When applying BM mode to a block, video encoder 200 and video decoder 300 may derive two initial motion vectors MV0 and MV1 using a signaled merge candidate index to select the merge candidate in a constructed merge list. When implementing bilateral matching, video encoder 200 and video decoder 300 search around the MV0 and MV1 and derive the final MV0′ and MV1′ based on a minimum bilateral matching cost.

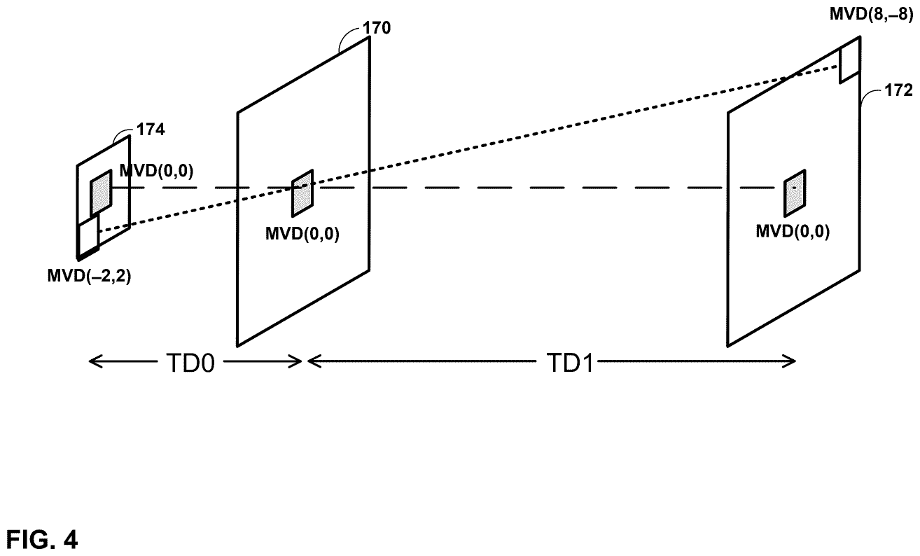

The motion vector difference (MVD) MVD0 (denoted by MV0′-MV0) and MVD1 (denoted by MV1′-MV1) pointing to the two reference blocks may be proportional to the temporal distances (TD), e.g., TD0 and TD1, between the current picture and the two reference pictures. FIG. 4 shows an example of MVD0 and MVD1 where the distance (TD1) between current picture 170 and reference picture 172 is 4-times the distance (TD0) between current picture 170 and reference picture 174. FIG. 4 shows an example of MVD0 and MVD1 being proportional based on the temporal distances.

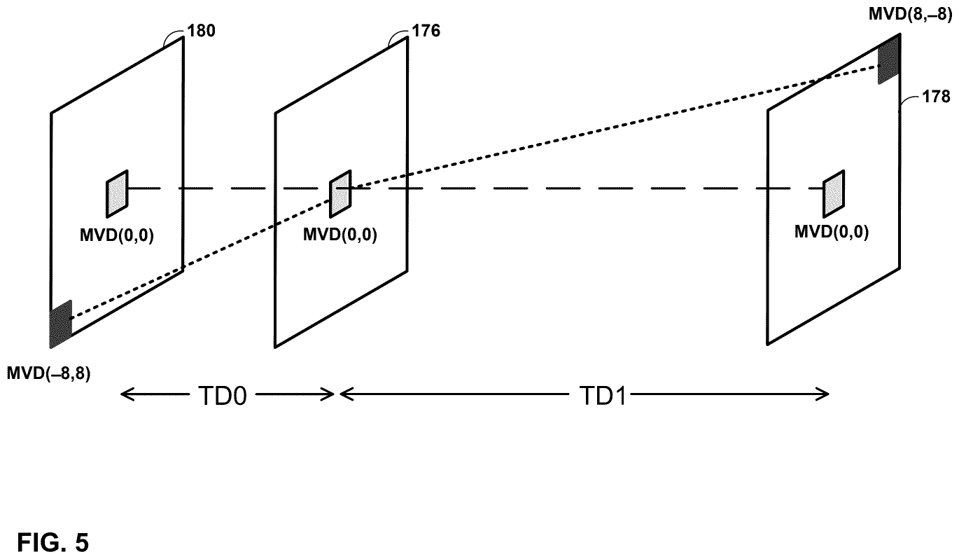

However, there is an optional design where MVD0 and MVD1 are mirrored regardless of the temporal distances TD0 and TD1. FIG. 5 shows an example of MVD0 and MVD1 being mirrored regardless of the temporal distance (TD1) between current picture 176 and reference picture 178 and the temporal distance (TD0) between current picture 176 and reference picture 180. FIG. 5 shows an example of mirrored MVD0 and MVD1, where TD1 is 4-times of TD0.

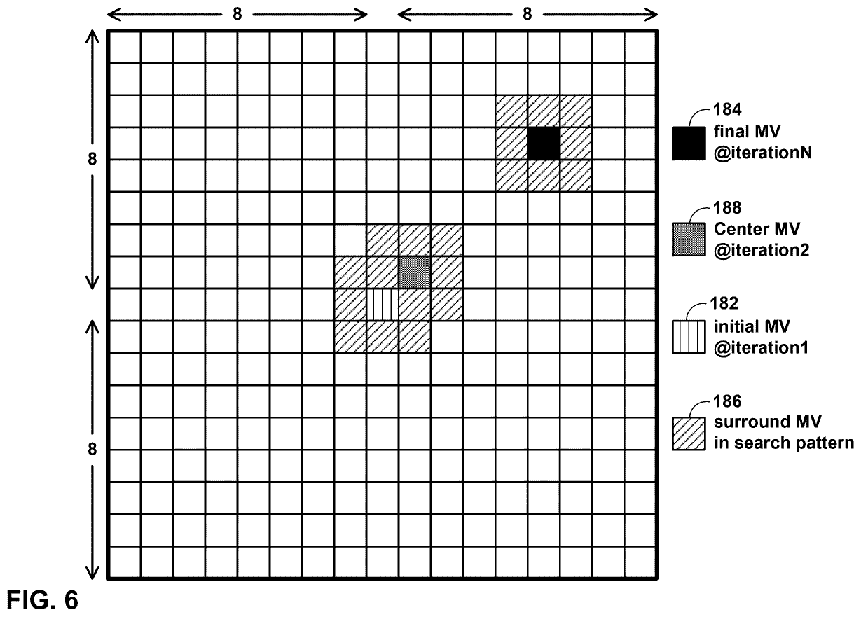

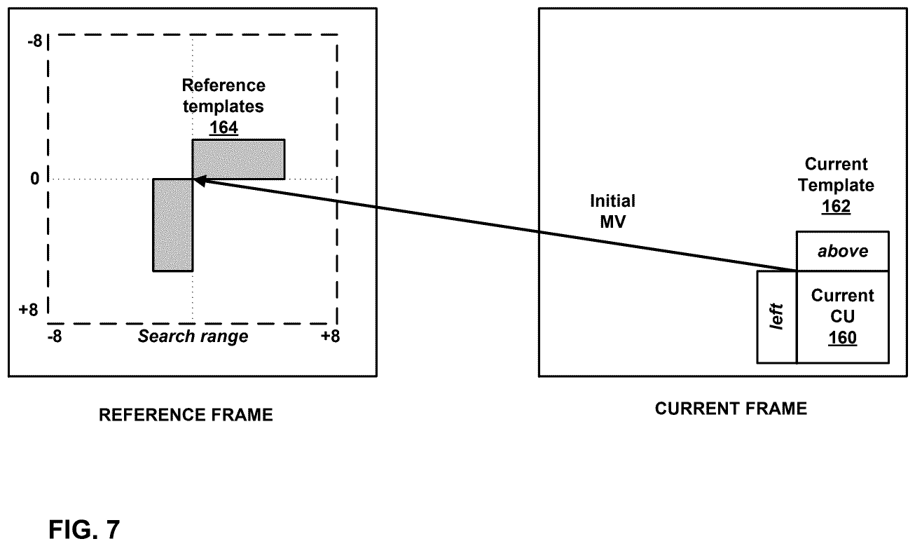

FIG. 6 is a conceptual diagram illustrating an example of the 3×3 square search pattern in the search range [−8, 8]. FIG. 6 shows an example of 3×3 square search patterns in the search range [−8, 8] for implementing bilateral matching. When implementing bilateral matching, video encoder 200 and video decoder 300 may be configured to perform a local search around the initial MV0 and MV1 to derive the final MV0′ and MV1′. In the example of FIG. 7, the initial MV points to sample 182, and the final MV points to sample 184. The local search applies a 3×3 square search pattern to loop through the search range [−8, 8]. Samples 186 represent examples of samples in the search range around samples 182, 184, and sample 188. Sample 188 represents an example of a sample corresponding to a MV determined during an intermediate iteration of the search process. In each search iteration, the bilateral matching cost of the eight surrounding MVs in the search pattern are calculated and compared to the bilateral matching cost of center MV. The MV which has minimum bilateral matching cost becomes the new center MV in the next search iteration. The local search is terminated when the current center MV has a minimum cost within the 3×3 square search pattern or the local search reaches the pre-defined maximum search iteration.

Template matching prediction is now described. Video coders, such as video encoder 200 or video decoder 300, may implement template matching prediction. Template matching (TM) prediction is a special merge mode based on Frame-Rate Up Conversion (FRUC) techniques. With this mode, motion information of a block is not signaled but is derived at decoder side. TM may be applied to both AMVP mode and regular merge mode. In AMVP mode, MVP candidate selection is determined based on template matching to select the candidate which reaches the minimal difference between current block template and reference block template. In regular merge mode, a TM mode flag is signaled to indicate the use of TM and then TM is applied to the merge candidate indicated by merge index for MV refinement.

FIG. 7 is a conceptual diagram illustrating an example of template matching performed on a search area around an initial MV. As shown in FIG. 7, template matching is used to derive motion information of current CU 160 by finding the closest match between a current template 162 in the current picture and a reference template 164, which may be the same size as current template 162, in a reference picture. Both current template 162 and reference template 164 may include respective above and left portions, as shown. With an AMVP candidate selected based on initial matching error, video encoder 200 and video decoder 300 may refine the MVP using template matching. With a merge candidate indicated by signaled merge index, video encoder 200 and video decoder 300 may be configured to refine MVs corresponding to L0 and L1 independently by template matching and then further refine the less accurate MV based on the more accurate MV.

Video encoder 200 and video decoder 300 may be configured to implement a cost function. When a motion vector points to a fractional sample position, motion compensated interpolation is needed. To reduce complexity, bi-linear interpolation instead of regular 8-tap DCT-IF interpolation is used for both template matching to generate templates on reference pictures. The matching cost C of template matching is calculated as follows:

$$C = SAD + w \cdot ( \vert {MV}_{x} - {MV}_{x}^{s} \vert + \vert {MV}_{y} - {MV}_{y}^{s} \vert )$$

where w is a weighting factor which is empirically set to 4, MV and MVS indicate the currently testing MV and the initial MV (i.e., an MVP candidate in AMVP mode or merged motion in merge mode), respectively. SAD is used as the matching cost of template matching.

When TM is used, motion is refined by using luma samples only. The derived motion will be used for both luma and chroma for MC inter prediction. After MV is decided, final MC is performed using 8-taps interpolation filter for luma and 4-taps interpolation filter for chroma.

Video encoder 200 and video decoder 300 may be configured to implement a search process. MV refinement is a pattern based MV search with the criterion of template matching cost. Two search patterns are supported—a diamond search and a cross search for MV refinement. The MV is directly searched at quarter luma sample MVD accuracy with diamond pattern, followed by quarter luma sample MVD accuracy with cross pattern, and then this is followed by one-eighth luma sample MVD refinement with cross pattern. The search range of MV refinement is set equal to (−8, +8) luma samples around the initial MV. When the current block is of bi-prediction, both MVs are refined independently, and then the best of which (in terms of matching cost) is set as a prior to further refine the other MV with bi-prediction with CU-based weighting (BCW) weight values.

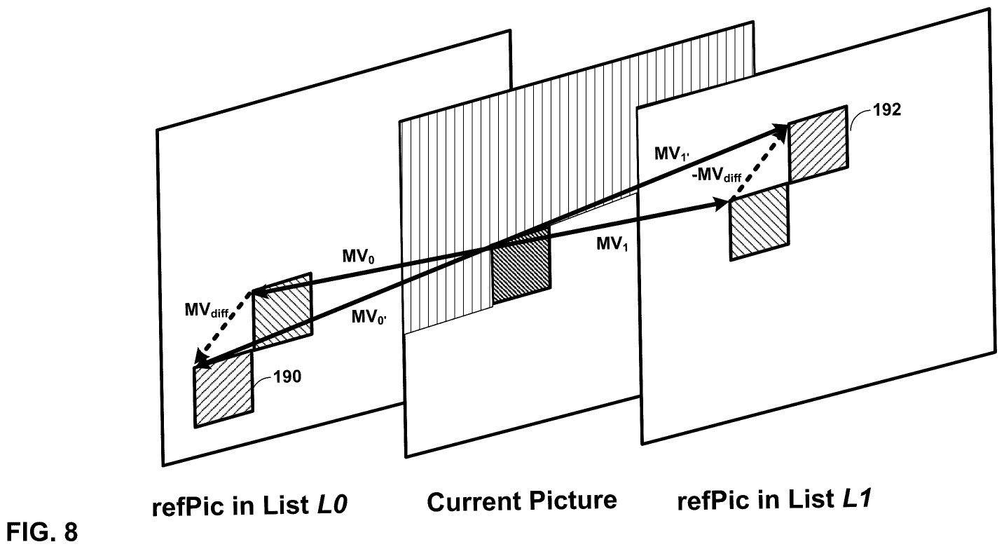

Decoder-side Motion Vector Refinement is now discussed. To increase the accuracy of the MVs of the merge mode, a decoder side motion vector refinement (DMVR) is applied in VVC. In a bi-prediction operation, a refined MV is searched around the initial MVs in the reference picture list L0 and reference picture list L1. The DMVR method calculates the distortion between the two candidate blocks in the reference picture list L0 and list L1. As illustrated in FIG. 8, the SAD between blocks 190 and 192 based on each MV candidate around the initial MV is calculated. The MV candidate with the lowest SAD becomes the refined MV and used to generate the bi-predicted signal.

The refined MV derived by DMVR process is used to generate the inter prediction samples and also used in temporal motion vector prediction for future pictures coding. While the original MV is used in deblocking process and also used in spatial motion vector prediction for future CU coding.

DMVR is a sub-block based merge mode with a pre-defined maximum processing unit of 16×16 luma samples. When the width and/or height of a CU are larger than 16 luma samples, it will be further split into subblocks with width and/or height equal to 16 luma samples.

A searching scheme is now discussed. In DMVR, the search points are surrounding the initial MV and the MV offset by the MV difference mirroring rule. In other words, any points that are checked by DMVR, denoted by candidate MV pair (MV0, MV1) follow the two equations:

$$MV {0}^{′} = MV 0 + MV\_offset$$

$$MV {1}^{′} = MV 1 - MV\_offset$$

Where MV_offset represents the refinement offset between the initial MV and the refined MV in one of the reference pictures. The refinement search range is two integer luma samples from the initial MV. The searching includes the integer sample offset search stage and fractional sample refinement stage.

A 25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, the original MV may be favored during the DMVR process. The SAD between the reference blocks referred by the initial MV candidates is decreased by ¼ of the SAD value.

The integer sample search is followed by fractional sample refinement. To save on calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

Bilinear-interpolation and sample padding is now described. Video decoder 300, may implement bilinear-interpolation and/or sample padding. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect of using the bi-linear filter is that with a 2-sample search range, the DMVR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

Enabling conditions for DMVR are now discussed. DMVR is enabled if the following conditions are all satisfied: 1) CU level merge mode with bi-prediction MV; 2) One reference picture is in the past and another reference picture is in the future with respect to the current picture; 3) The distances (i.e. POC difference) from both reference pictures to the current picture are same; 4) CU has more than 64 luma samples; 5) Both CU height and CU width are larger than or equal to 8 luma samples; 6) bi-prediction with CU-based weighting (BCW) weight index indicates equal weight; 7) weighted prediction (WP) is not enabled for the current block; and 8) combined intra-inter prediction (CIIP) mode is not used for the current block.

Multi-pass decoder-side motion vector refinement in Enhanced Compression Model (ECM) is now discussed. A multi-pass decoder-side motion vector refinement may be applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

First pass—Block based bilateral matching MV refinement is now discussed. In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initial MVs based on the minimum bilateral matching cost between the two reference blocks in L0 and L1.

Video encoder 200 or video decoder 300 implementing BM performs a local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost may be calculated as: bilCost=mvDistanceCost+sadCost. When the block size cbW*cbH is greater than 64, mean reduced sum of average difference (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and video encoder 200 or video decoder 300 may continue to search for the minimum cost, until video encoder 200 or video decoder 300 reaches the end of the search range.

The existing fractional sample refinement is further applied to derive the final deltaMV. The refined MVs after the first pass is then derived as:

$$MV0\_pass1 = MV 0 + deltaMV$$

$$MV1\_pass1 = MV 1 - deltaMV$$

Second pass—Subblock based bilateral matching MV refinement is now discussed. In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2 (sbIdx2) and MV1_pass2 (sbIdx2)) are derived based on the minimum bilateral matching cost between the two reference subblocks in L0 and L1.

For each subblock, video encoder 200 or video decoder 300 implementing BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

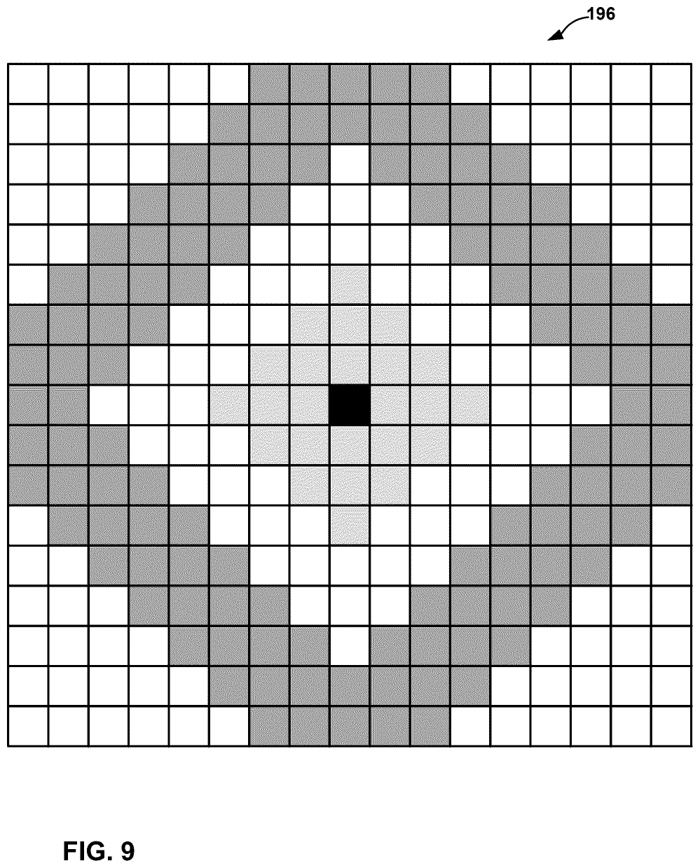

FIG. 9 is a conceptual diagram illustrating example diamond regions in a search area. The bilateral matching cost is calculated by applying a cost factor to the sum of transformed absolute differences (SATD) cost between two reference subblocks, as: bilCost=satdCost*costFactor. The search area (2*sHor+1)*(2*sVer+1) is divided up to 5 diamond shape search regions in search area 196 as shown on FIG. 9. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined.

The existing VVC DMVR fractional sample refinement is further applied to derive the final deltaMV(sbIdx2). The refined MVs at second pass is then derived as:

$$MV0\_pass2 ( sbIdx 2 ) = MV0\_pass1 + deltaMV ( sbIdx 2 )$$

$$MV1\_pass2 ( sbIdx 2 ) = MV1\_pass1 - deltaMV ( sbIdx 2 )$$

The third pass—Subblock based bi-directional optical flow MV refinement—is now described. In the third pass, a refined MV is derived by applying BDOF to an 8×8 grid subblock. For each 8×8 subblock, BDOF refinement is applied to derive scaled Vx and Vy without clipping starting from the refined MV of the parent subblock of the second pass. The derived bioMv (Vx, Vy) is rounded to 1/16 sample precision and clipped between −32 and 32.

The refined MVs (MV0_pass3(sbIdx3) and MV1_pass3(sbIdx3)) at third pass may be derived as:

$$MV0\_pass3 ( sbIdx 3 ) = MV0\_pass2 ( sbIdx 2 ) + bioMv$$

$$MV1\_pass3 ( sbIdx 3 ) = MV0\_pass2 ( sbIdx 2 ) - bioMv$$

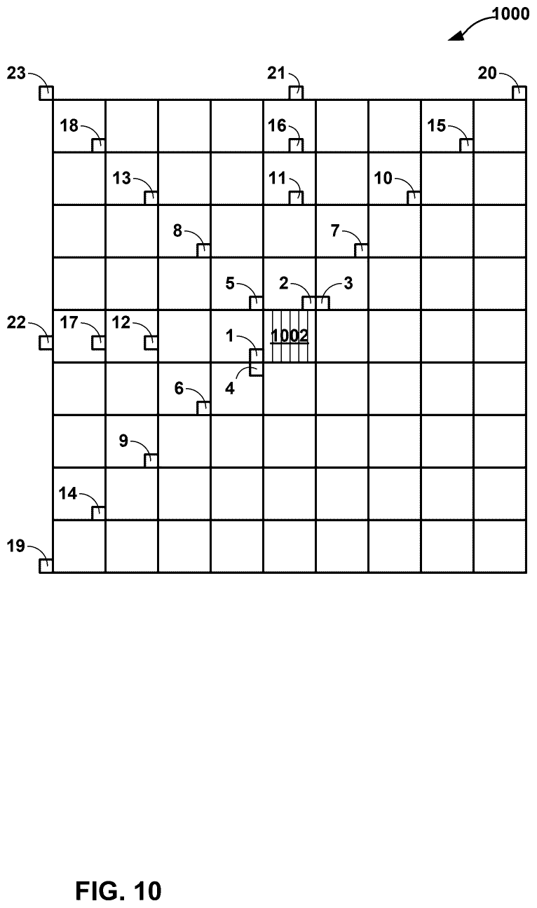

Non-adjacent spatial candidates in ECM are now described. Video encoder 200 or video decoder 300 may use non-adjacent spatial candidates. The non-adjacent spatial merge candidates as in JVET-L0399 are inserted after the TMVP in the regular merge candidate list. FIG. 10 is a conceptual diagram illustrating example spatial neighboring blocks used to derive the spatial merge candidates. The pattern 1000 of potential spatial merge candidates of current block 1002 is shown in FIG. 10. These potential spatial merge candidates are labeled 1-23. The distances between non-adjacent spatial candidates and current coding block are based on the width and height of current coding block (e.g., current block 1002). The line buffer restriction is not applied.

Adaptive decoder-side motion vector refinement in ECM is now described. Video decoder 300 may implement adaptive decoder-side motion vector refinement. Adaptive decoder-side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1st pass (i.e., PU level) DMVR.

The merge candidates for the new merge mode are derived from spatial neighboring coded blocks, TMVPs, non-adjacent blocks, history-based motion vector predictors (HMVPs), pair-wise candidate, similar as in the regular merge mode. The difference is that only those meet DMVR conditions are added into the candidate list. The same merge candidate list is used by the two new merge modes. Merge index is coded as in regular merge mode.

Adaptive reordering of merge candidates with template matching (ARMC-TM) in ECM is now described. Video coders, such as video encoder 200 or video decoder 300 may implement adaptive reordering of merge candidates with template matching. The merge candidates may be adaptively reordered with template matching (TM). The reordering method is applied to regular merge mode, template matching (TM) merge mode, and affine merge mode (excluding the SbTMVP candidate). For the TM merge mode, merge candidates are reordered before the TM refinement process.

After a merge candidate list is constructed, merge candidates are divided into several subgroups. The subgroup size is set to 5 for regular merge mode and TM merge mode. The subgroup size is set to 3 for affine merge mode. Merge candidates in each subgroup are reordered ascendingly according to cost values based on template matching. For simplification, merge candidates in the last but not the first subgroup are not reordered.

The template matching cost of a merge candidate may be measured by the sum of absolute differences (SAD) between samples of a template of the current block and their corresponding reference samples. The template comprises a set of reconstructed samples neighboring to the current block. Reference samples of the template are located by the motion information of the merge candidate.

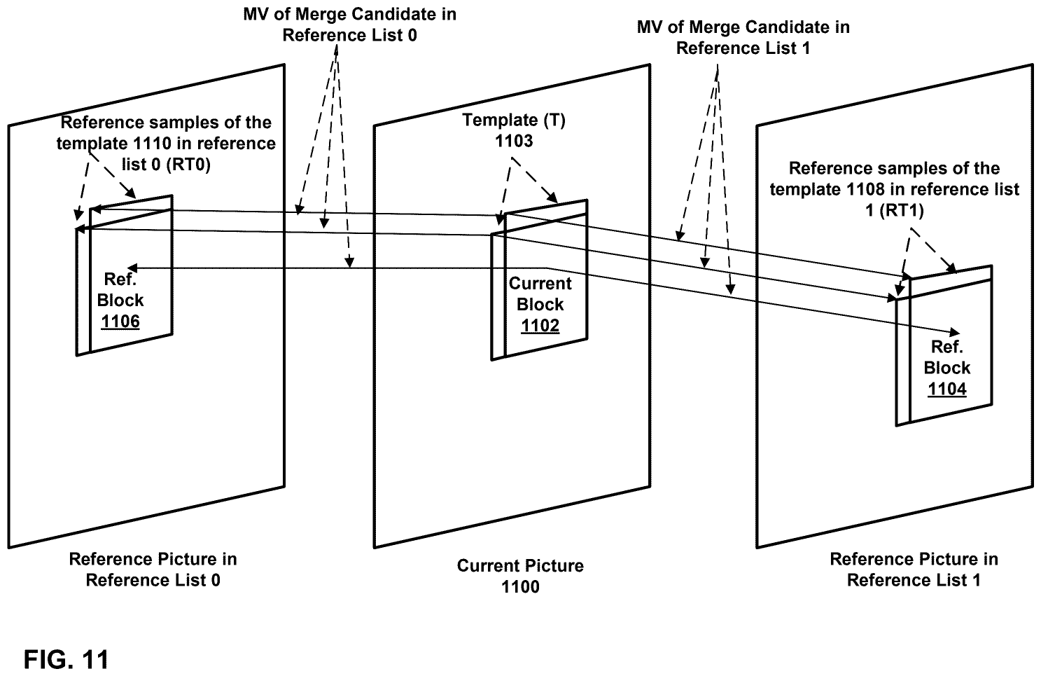

FIG. 11 is a conceptual diagram illustrating an example of template matching. When a merge candidate utilizes bi-directional prediction, the reference samples of the template of the merge candidate may also be generated by bi-prediction as shown in FIG. 11. For example, FIG. 11 illustrates current picture 1100 having current block 1102, and template 1103 that includes samples above and left of current block 1102. A first motion vector points to reference block 1104 that defines a first reference template 1108 that includes samples above and left of reference block 1104. A second motion vector points to reference block 1106 that defines a second reference template 1110 that includes samples above and left of reference block 1106.

For subblock-based merge candidates with subblock size equal to Wsub×Hsub, the above template comprises several sub-templates with the size of Wsub×1, and the left template comprises several sub-templates with the size of 1×Hsub.

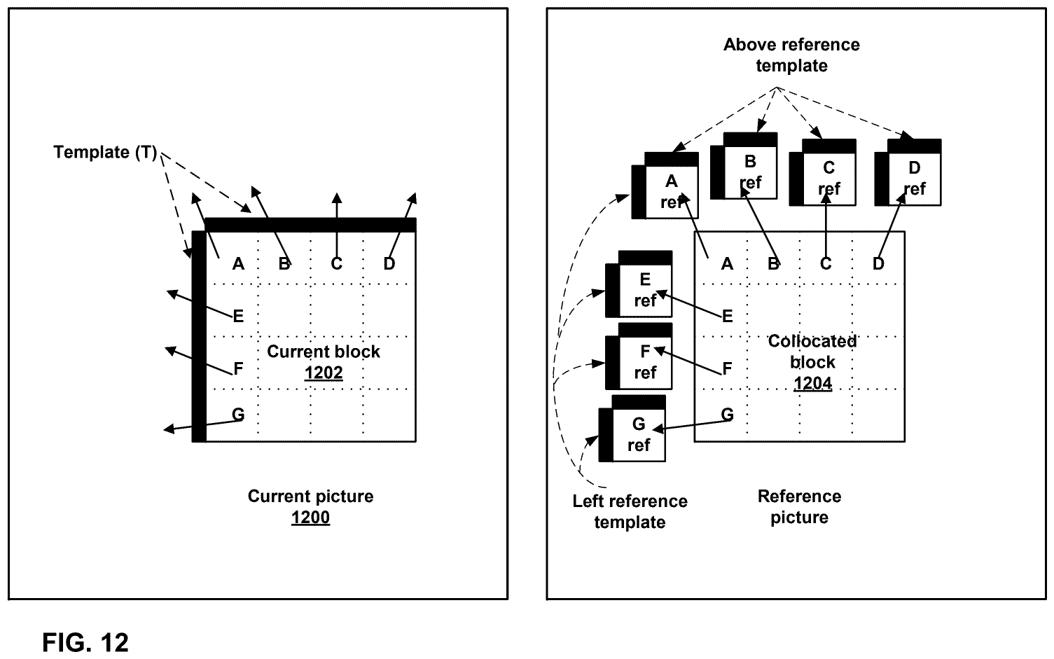

FIG. 12 is a conceptual diagram illustrating an example of sub-block based template matching. As shown in FIG. 12, the motion information of the subblocks in the first row and the first column of current block 1202 of current picture 1200 is used to derive the reference samples of each sub-template.

For instance, in FIG. 12, the collocated block 1204 may be an example of reference block 1104 or 1106 of FIG. 11. Reference template 1108 or 1110, of FIG. 11, as illustrated in FIG. 12, may include samples above and left of collocated block 1204.

Cost Functions in ECM are now described. Video coders, such as video encoder 200 or video decoder 300 may implement the cost functions of ECM. In ECM, multiple cost functions are defined and employed in different tools to quantify the distortion of a coding tool. Descriptions of some of the commonly employed cost functions in different tools follow.

SAD (Sum of Absolute Differences): Video encoder 200 or video decoder 300 implementing SAD measure the absolute pixel intensity differences. Video encoder 200 or video decoder 300 implementing SAD sum up the absolute value of these differences.

SATD (Sum of Transformed Absolute Differences): Video encoder 200 or video decoder 300 implementing SATD measure the summation for the absolute differences after applying a transform (e.g., Hadamard transform).

SSE (Sum of Squared Error): SSE is used in the rate-distortion process to measure the distortion, to maximize the peak signal-to-noise ratio (PSNR) of the reconstructed video sequences.

Weighted-SAD (Weighted Sum of Absolute Differences): Weighted-SAD is commonly used in template-matching based tools. Video encoder 200 or video decoder 300 implementing weighted SAD assign different weights to different lines of a template to achieve more efficient template matching.

MR-SAD (Mean-Removal Sum of Absolute Differences): Video encoder 200 or video decoder 300 implementing MR-SAD first calculates the mean value of the original block. Video encoder 200 or video decoder 300 implementing MR-SAD subtract the mean value from the original block, and then calculate the SAD.

MR-SATD (Mean-Removal Sum of Transformed Absolute Differences): Similar to MR-SAD, video encoder 200 or video decoder 300 implementing MR-SATD derive the mean value from the original block. Video encoder 200 or video decoder 300 implementing MR-SATD then remove the mean value from the original image block and follow the same steps to calculate the SATD.

MS-SATD (Mean-Scaled Sum of Transformed Absolute Differences): Video encoder 200 or video decoder 300 implementing MS-SATD follow similar steps of SATD calculation. The only difference is that a weight is applied to the absolute values of the DC coefficient after a transform process. In ECM, this weight is set to a quarter (right shift by 2).

In a draft of ECM, different cost functions are mostly manually chosen for various coding tools or in different coding stages to quantify the cost of a coding tool. In other words, the cost function to be used for a given coding tool or a given stage is determined by the drafters of the ECM standard and is generally implemented in a video codec as chosen by the drafters (e.g., manually chosen). For example, during the multi-pass decoder-side motion vector refinement search process, the PU-level search uses SAD as the cost function, while the sub-PU level search uses SATD as the cost function. However, when applying the same cost function to refine the merge candidates, it is possible that different merge candidates may yield very similar refined results. This lack of diversity among merge candidates can potentially impact performance, leading to sub-optimal refinement results, such as less efficient coding and/or lower decoded video quality.

This disclosure describes techniques for leveraging adaptive cost function selection (e.g., the adaptive selection of cost functions) for inter prediction. In some examples, the disclosed techniques may be applied to motion vector refinement processes, such as decoder-side motion vector derivation techniques, e.g., bilateral matching, template matching based merge candidate refinement, etc. The adaptive cost function selection techniques of this disclosure may also apply to a motion vector predictor (MVP) reordering processes, such as template matching cost-based MVP reordering, bilateral matching cost-based MVP reordering, etc. Video encoder 200 and/or video decoder 300 may apply the techniques of this disclosure. For example, video decoder 300 may refine at least one motion vector associated with the prediction candidate based on a first cost function of a plurality of cost functions and/or video decoder 300 may reorder motion vector predictors in motion vector predictor list based on the first cost function.

According to the techniques of this disclosure, a cost function may be one of the cost functions listed above. However, the techniques of this disclosure are not limited to the listed cost functions-SAD, SATD, MR-SAD, MR-SATD, MS-SAD, MS-SATD. Any cost function may be used and the use of any cost function (including those not described herein) should be considered to be within scope of this disclosure. For example, video encoder 200 or video decoder 300 may apply any of the listed cost functions or any other cost functions.

The techniques of this disclosure apply to one or several inter prediction modes, e.g., regular merge mode, template matching merge mode, bilateral matching merge mode, geometric partitioning merge mode, AMVP-merge mode, affine mode, etc.

The techniques of this disclosure may apply to certain types of slices, or pictures. In one example, the techniques are only applied to one or more of a random access (RA), a low delay B (LDB), or a low delay P (LDP), slice or picture. For example, prior to applying the techniques of this disclosure to determine a first cost function to apply to a current block, video decoder 300 may determine that a current block is a block of an RA slice, an RA picture, a LDB slice, an LDB picture, an LDP slice, or an LDP picture.

Merge index-based cost function selection is now described. Video encoder 200 and/or video decoder 300 may use one or more of these merge index-based cost function selection techniques. In this example, when a block is predicted using a list of motion candidates (e.g., a merge list of merge candidates), a candidate index (e.g., a merge index) may be used to indicate not only a particular candidate in a candidate list, but also a cost function. In this example, a candidate index may indicate a candidate used for motion prediction and a cost function to be used to derive the inter block predictor. For example, with the current block is an inter merge mode predicted block, the merge index, which is signaled in the bitstream, is used to indicate a cost function for the current block. For example, the value of the merge index may indicate both a particular candidate in the merge list and a cost function to use for the current block. In one example, the determined cost function is used in a motion vector refinement process, e.g., template matching-based MV refinement, bilateral matching-based MV refinement, etc. In one example, the block is a subblock of a prediction block. For example, the current block may be a current subblock.

For example, video encoder 200 may determine to encode a current block of the video data using an inter mode. Video encoder 200 may determine a prediction candidate and a cost function for the current block. Video encoder 200 may signal, in a bitstream, a single syntax element having a value indicative of both the prediction candidate and the cost function. Video encoder 200 may encode the current block based on the prediction candidate and the first cost function.

For example, video decoder 300 may determine to decode a current block of the video data using an inter mode. Video decoder 300 may determine a value of an index to a prediction candidate in a candidate list. Video decoder 300 may determine the prediction candidate and a first cost function of a plurality of cost functions based on the value of the index. Video decoder 300 may decode the current block based on the prediction candidate and the first cost function.

For example, there are N candidates in a merge list and there are M different cost functions, the merge candidate index may be used to indicate which cost function is adopted to refine the specific candidate. The merge index is, e.g. signaled in the bitstream, known to the decoder (e.g., video decoder 300), the same cost function will be selected at the encoder (e.g., video encoder 200) and decoder (e.g., video decoder 300) sides based on the merge index without any additional signaling. The merge index, denoted as mrgIdx, ranges from 0 to N−1. The cost function index, denoted as costFuncIdx, ranges from 0 to M−1. In one example, the mapping of the mrgIdx and costFuncIdx is predefined.

For example, video decoder 300 may determine to decode a second current block of the video data using the inter mode. Video decoder 300 may determine a value of an index to a second prediction candidate in a second candidate list. Video decoder 300 may determine that the second prediction candidate is in a second portion of the second candidate list. Video decoder 300 may determine, based on the second prediction candidate being in the second portion of the second candidate list, a second cost function. Video decoder 300 may decode the current block based on the second cost function.

The techniques of this disclosure may be applied to all N candidates in a merge list or a subset of the candidates. In one example, only the first X candidates in the merge list are using the techniques described herein to select the cost function. The cost function selection of the rest of the candidates remains unchanged. The number of cost functions M may be all applicable cost functions or only a subset of the available cost functions.

In one example, two cost functions (M=2) can be selected alternatively for every second candidate. For example, video encoder 200 or video decoder 300 may select two cost functions alternatively for every second candidate. For example, if the merge index is an odd number, then the first cost function is selected, otherwise (e.g., the merge index is an even number) the second cost function is selected. For example, a first cost function is determined based on selecting between the first cost function and a second cost function based on a parity of the value of the index, the first cost function being selected if the value of the index is odd and the second cost function being selected if the value of the index is even.

A cost function selection may be indicated by a cost function index selecting a cost function from a defined cost function list. For example, the M=2 cost functions may be SAD (e.g., cost function with an index equal to 0, costFuncIdx=0) and SATD (costFuncIdx=1), when the candidate index mrgIdx is an even number, e.g. divisible by 2, SAD is determined to be used with the merge candidate which is determined by the mrgIdx. In this example, when the mrgIdx is an odd number, SATD is determined to be used with the merge candidate which is determined by the mrgIdx. In one example, a cost function may be further determined or alternated by the block size, e.g., when the block size is greater than a threshold, use another cost function. For example, a mean removal cost function, is used for the block, in one case, the M=2 cost functions are MR-SAD and MR-SATD when block size is greater than a threshold, in another case, the M=2 cost functions are MR-SAD and SATD, when block size is greater than a threshold. In another case, the M=2 cost functions are MR-SAD and MS-SATD, when block size is greater than a threshold.

For example, the value of the index is either an odd number or an even number. The odd number is indicative of the first cost function and the even number is indicative of a second cost function. For example, video decoder 300 may determine the cost function further based on a block size of the current block. For example, the first cost function may be further determined based on selecting between the first cost function and a second cost function based on a block size of the current block, the first cost function being selected if the block size of the current block is a first size and the second cost function being selected if the value of the index is a second size.

In another example, if the number of candidates N is larger than the number of cost functions M, then the N candidates can be split into subgroups. In some examples, such as when Nis an integer multiple of M, each subgroup may have M candidates. Each candidate in a subgroup is refined with one of the M cost functions. For example, each candidate may be refined using a corresponding cost function, such that each candidate in the subgroup is refined using a different one of the M cost functions. For example, if the value of the merge index indicates a first candidate in any of the subgroups, a first cost function is used. If a value of the merge index indicates a second candidate in any of the subgroups, the second cost function is used, and so on. It should be understood that when N is not an integer multiple of M, one or more subgroups may have M candidates and other subgroups may have a different number of candidates, such as M−1 candidates.

For example, video decoder 300 may determine a plurality of subgroups of candidates in the candidate list, each subgroup of the plurality of subgroups having a number of candidates equal to a number of cost functions of the plurality of cost functions. For example, if there are five cost functions, there may be five candidates in a subgroup. Video decoder 300 may determine that the value of the index is associated with a first candidate in one of the subgroups, the first candidate of each subgroup being associated with the first cost function.

In yet another example, a mapping table may be created between the merge index and the cost function selection. One merge index is mapped to one specific cost function. This mapping can be generated by any rules defined above or any hand-crafted mapping rules. This mapping table may be known to both video encoder 200 and video decoder 300 to select the corresponding cost function based on a merge index.

For example, video decoder 300 may look up the value of the index in a mapping table, the mapping table mapping respective merge indexes to corresponding cost functions of the plurality of cost functions.

In another example, one merge candidate from the merge list may be refined with M different cost functions, respectively. For example, video encoder 200 or video decoder 300 may refine the one merge candidate with the M different cost functions, respectively. Then M different refined candidates may be generated, and these additional refined candidates may be appended into the merge candidate list. The list size may thereby be extended to N*M. Then the merge candidates may be sorted with any reordering technique (e.g., adaptive reordering of merge candidates with template matching, ARMC-TM, etc.) and the first N candidates will be kept as the final refined merge candidates. In another example, a candidate index (mrgIdx) before the candidate sorting (e.g. ARMC-TM) is used to determine a cost function A, and then the index mrgIdx after sorting is used to determine a cost function B.

Block size-based cost function selection is now described. Video encoder 200 and/or video decoder 300 may use one or more of these block size-based cost function selection techniques. In one example, when the block width is smaller than a threshold T, the cost function A is selected and used in all the MVP reordering and MV refinement processes. In one example, when the block height is smaller than a threshold T, the cost function A is selected and used in all the MVP reordering and MV refinement processes. In one example, when the block width is greater than a threshold T, the cost function A is selected and used in all the MVP reordering and MV refinement processes. In one example, when the block height is greater than a threshold T, the cost function A is selected and used in all the MVP reordering and MV refinement processes. In these examples, the cost function A may be one of SAD, SATD, MR-SAD, MR-SATD, MS-SAD, MS-SATD, or any other cost function.

Prediction mode-based cost function selection is now described. Video encoder 200 and/or video decoder 300 may use one or more of these prediction mode-based cost function selection techniques. For example, video encoder 200 or video decoder 300 may determine which cost function to use for motion vector refinement and/or motion vector predictor reordering based on the prediction mode use for the current block, such as template matching merge mode, bilateral matching merge mode, AMVP-merge mode, affine bilateral matching merge mode, or affine template matching merge mode.

In one example, when a block is determined to be template matching merge mode predicted block, e.g. indicated by a flag signaled in the bitstream, the cost function A is selected and used in all the MVP reordering and MV refinement processes. In one example, when a block is determined to be bilateral matching merge mode predicted block, e.g., indicated by a flag signaled in the bitstream (e.g., by video encoder 200), the cost function A is selected and used in all the MVP reordering and MV refinement processes. In one example, when a block is determined to be AMVP-Merge mode predicted block, e.g., indicated by a flag signaled in the bitstream (e.g., by video encoder 200), the cost function A is selected and used in all the MVP reordering and MV refinement processes. In one example, when a block is determined to be affine bilateral matching merge mode predicted block, e.g., indicated by a flag signaled in the bitstream (e.g., by video encoder 200), the cost function A is selected and used in all the MVP reordering and MV refinement processes. In one example, when a block is determined to be affine template matching merge mode predicted block, the cost function A is selected and used in all the MVP reordering and MV refinement processes. In these examples, the cost function A may be one of SAD, SATD, MR-SAD, MR-SATD, MS-SAD, MS-SATD, or any other cost function.

Cost function selection with signaling is now described. In this example, flags are signaled into the bitstream to indicate the decision of the cost function selection. For example, video encoder 200 may signal such flags. The flags can be signaled in one or more VPS, SPS, PPS, picture header, slice header, or per block, to indicate the cost functions used.

In one example, there are M different cost functions, and the candidates in the merge list can be refined with each of the cost functions. The cost function decision with the best rate-distortion performance may be signaled as a flag into the bitstream for each block. For example, video encoder 200 may signal the flag. At the decoder, the cost function decision flag is decoded, and the corresponding cost function is selected to perform the same refinement process. For example, video decoder 300 may parse the flag to determine the cost function decision having the best rate-distortion performance.

In one example, two cost functions (M=2) can be selected and tested for refinement of each candidate in the merge list. These two cost functions may be SAD (cost function index equals to 0, costFuncIdx=0) and SATD (costFuncIdx=1). The final decision of cost function index (costFuncIdx=0 or 1) may be signaled into the bitstream, e.g., by video encoder 200.

In another example, different cost functions can be selected and signaled in different stages of coding. For example, before merge candidate reordering (e.g., ARMC-TM), cost function A and cost function B may be selected to refine the merge candidates and the cost function index may be signaled, e.g., by video encoder 200. After reordering of the candidates, cost function C and D may be selected to refine the candidates, and the cost function index may be signaled, e.g., by video encoder 200. In these examples, the cost function A may be one of SAD, SATD, MR-SAD, MR-SATD, MS-SAD, MS-SATD, or any other cost function.

In another example, cost function selection with signaling and any technique described of this disclosure can be combined and jointly applied. In one example, during the multi-pass decoder-side motion vector refinement search process, the PU-level search is using SAD or SATD as the cost function and cost function index (0 or 1) is signaled into the bitstream. The sub-PU level refinement is using SATD or MR-SATD based on the merge index as described above in the discussion of merge index-based cost function selection.

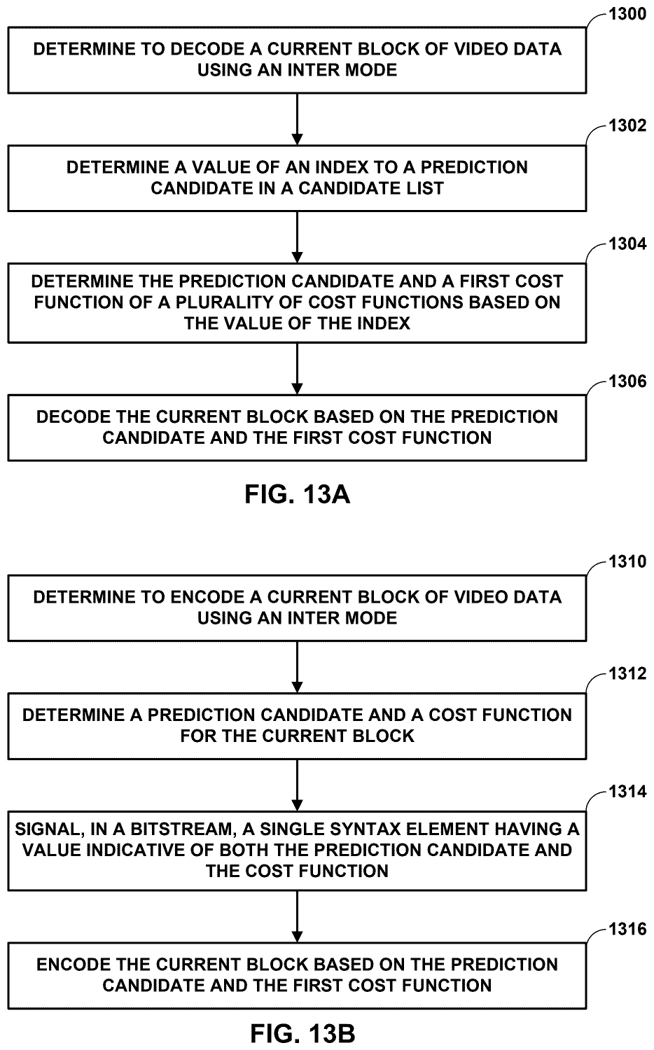

FIG. 13A is a flowchart illustrating an example of adaptive cost function selection according to one or more aspects of this disclosure. Video decoder 300 may determine to code a current block of the video data using an inter mode (1300). For example, video encoder 200 may determine that a best (e.g., most accurate and/or efficient) encoding mode for the current block is an inter mode. Video encoder 200 may signal, in a bitstream, encoded data representing the current block and a syntax element whose value is indicative of the inter mode used to encode the current block. Video decoder 300 may obtain, in a bitstream, a syntax element whose value is indicative the current block being encoded using an inter mode. Video decoder 300 may parse the syntax element to determine the value of the syntax element and thereby determine that the current block should be decoded using the inter mode indicated by the syntax element.

Video decoder 300 may determine a value of an index to a prediction candidate in a candidate list (1302). For example, video encoder 200 may signal, in a bitstream, an index to a prediction candidate in a candidate list to indicate to video decoder 300 which prediction candidate video decoder 300 should use to predict the current block. Video decoder 300 may then parse the index to determine the value of the index.

Video decoder 300 may determine the prediction candidate and a first cost function of a plurality of cost functions based on the value of the index (1304). For example, the index may be indicative of both a prediction candidate in the candidate list and a particular cost function of a plurality of cost functions. By parsing the index, video decoder 300 may thereby determine both the prediction candidate and the first cost function to use to decode the current block. As such the particular cost function may be associated with the value of the index.

Video decoder 300 may decode the current block based on the prediction candidate and the first cost function (1306). For example, video decoder 300 may apply the first cost function to refine a motion vector associated with the prediction candidate and/or reorder motion vectors in a motion vector predictor list. Video decoder 300 may use one or more of the motion vectors may predict the current block.

For example, video decoder 300 may, as part of decoding the current block based on the prediction candidate and the first cost function, apply the cost function between samples of different blocks identified based on a motion vector associated with the prediction candidate to determine an aggregate difference between the different blocks and use that aggregate difference to refine a motion vector associated with the prediction candidate and/or reorder motion vectors in a motion vector predictor list.

In some examples, the first cost function is determined based on selecting between the first cost function and a second cost function based on a parity of the value of the index, the first cost function being selected if the value of the index is odd and the second cost function being selected if the value of the index is even. For example, the value of the index is either an odd number or an even number, and wherein the odd number is indicative of the first cost function and the even number is indicative of a second cost function.

In some examples, as part of decoding the current block, video decoder 300 may refine at least one motion vector associated with the prediction candidate based on the first cost function. In some examples, as part of decoding the current block, video decoder 300 may reorder motion vector predictors in motion vector predictor list based on the first cost function.

In some examples, the inter mode includes a regular merge mode, a template matching merge mode, a bilateral matching merge mode, a geometric partitioning merge mode, an AMVP-merge mode, or an affine mode. In some examples, video decoder 300 may be configured to determine the first cost function further based on a type of the inter mode. For example, different cost functions may be used for different types of inter modes. For example, the first cost function may be used when the inter mode is a regular merge mode and a second cost function may be used when the inter mode is a template matching merge mode.

In some examples, as part of decoding the current block, video decoder 300 may apply the first cost function to at least one candidate of a candidate list. In some examples, the first cost function includes a sum of absolute differences (SAD), a sum of transformed absolute differences (SATD), a sum of squared error (SSE), a weighted-SAD, a mean-removal (MR)-SAD, a MR-SATD, or a mean-scaled-SATD. In some examples, the current block includes a block of a random access (RA) slice, an RA picture, a low delay B (LDB) slice, an LDB picture, a low delay P (LDP) slice, or an LDP picture.

In some examples, as part of determining the first cost function, video decoder 300 may determine a plurality of subgroups of candidates in a candidate list, each subgroup of the plurality of subgroups having a number of candidates equal to a number of cost functions of the plurality of cost functions. Video decoder 300 may determine that the value of the index is associated with a first candidate in one subgroup of the plurality of subgroups, the first candidate of each subgroup of the plurality of subgroups being associated with the first cost function.

In some examples, as part of determining the first cost function, video decoder 300 may look up the value of the index in a mapping table, the mapping table mapping respective merge indexes to corresponding cost functions of the plurality of cost functions. In some examples, video decoder 300 may determine the first cost function further based on a block size of the current block. In some examples, the current block comprises (or is) a current subblock. For example, the first cost function may be further determined based on selecting between the first cost function and a second cost function based on a block size of the current block, the first cost function being selected if the block size of the current block is a first size and the second cost function being selected if the value of the index is a second size.

In some examples, the prediction candidate is a first prediction candidate, the candidate list is a first candidate list, the first prediction candidate is in a first portion of the first candidate list, and the current block is a first current block. In some examples, video decoder 300 may determine to code a second current block of the video data using the inter mode. Video decoder 300 may determine a value of an index to a second prediction candidate in a second candidate list. Video decoder 300 may determine that the second prediction candidate is in a second portion of the second candidate list. Video decoder 300 may determine, based on the second prediction candidate being in the second portion of the second candidate list, a second cost function. Video decoder 300 may decode the current block based on the second cost function.

FIG. 13B is a flowchart illustrating another example of adaptive cost function selection according to one or more aspects of this disclosure. Video encoder 200 may determine to encode a current block of the video data using an inter mode (1310). For example, video encoder 200 may determine that using an inter mode is the most efficient and/or accurate way of encoding the current block.

Video encoder 200 may determine a prediction candidate and a cost function for the current block (1312). For example, video encoder 200 may determine a prediction candidate and a cost function to be used to predict the current block.

Video encoder 200 may signal, in a bitstream, a single syntax element having a value indicative of both the prediction candidate and the cost function (1314). For example, video encoder 200 may signal an index to a candidate list that may be indicative of both the prediction candidate and the cost function.

Video encoder 200 may encode the current block based on the prediction candidate and the first cost function (1316). For example, video encoder 200 may, as part of coding the current block, apply the cost function between samples of different blocks identified based on a motion vector associated with the prediction candidate to determine an aggregate difference between the different blocks and use that aggregate difference to refine a motion vector associated with the prediction candidate and/or reorder motion vectors in a motion vector predictor list.

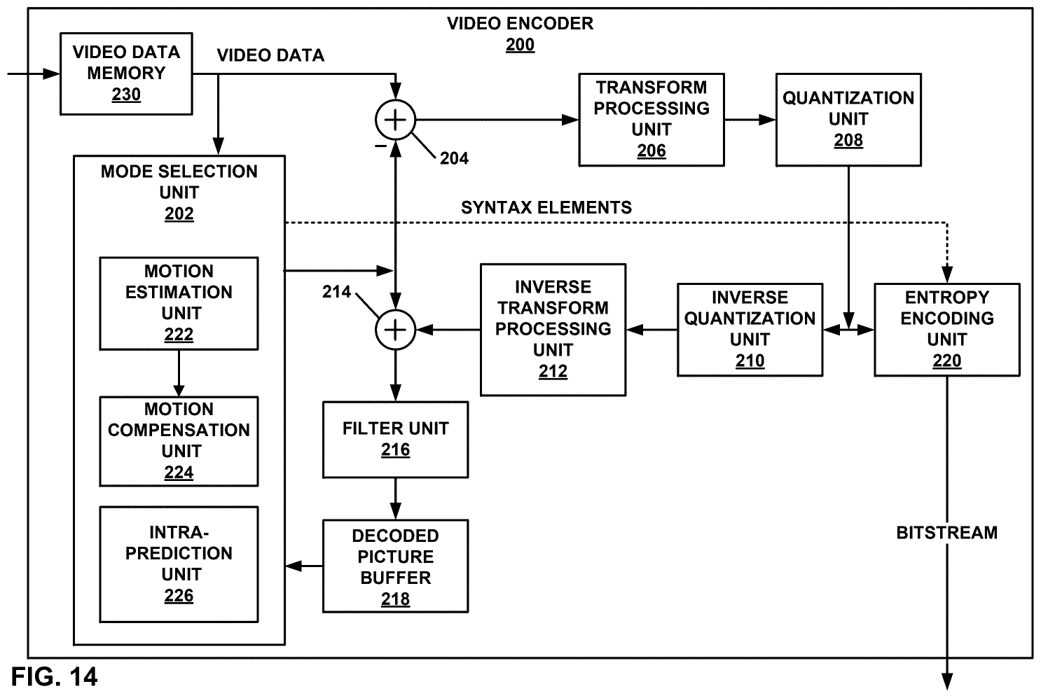

FIG. 14 is a block diagram illustrating an example video encoder 200 that may perform the techniques of this disclosure. FIG. 14 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 14, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 is an example of a memory system that may store video data to be encoded by the components of video encoder 200. Video encoder 200 may receive the video data stored in video data memory 230 from, for example, video source 104 (FIG. 1). DPB 218 is an example of a memory system that may act as a reference picture memory that stores reference video data for use in prediction of subsequent video data by video encoder 200. Video data memory 230 and DPB 218 may each be formed by any of a variety of one or more memory devices or memory units, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 14 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quad-tree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared errors (SSE), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to adaptively determine a cost function; and encode the video data based on the determined cost function.

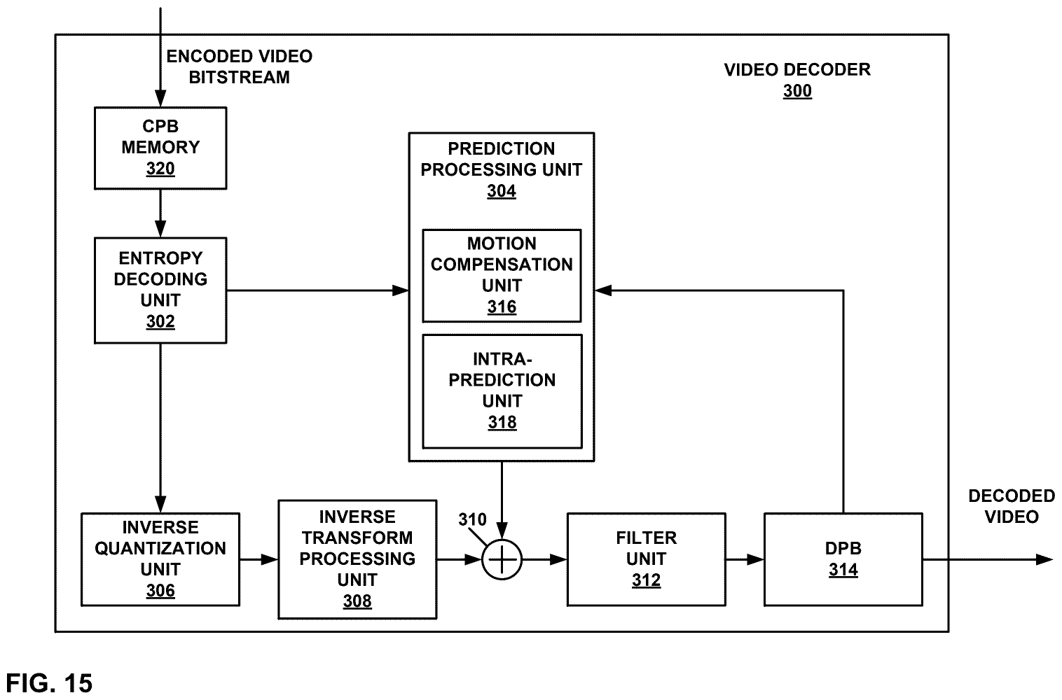

FIG. 15 is a block diagram illustrating an example video decoder 300 that may perform the techniques of this disclosure. FIG. 15 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 15, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 is an example of a memory system that may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 is an example of a memory system that generally stores decoded pictures, which video decoder 300 may output and/or use as reference video data when decoding subsequent data or pictures of the encoded video bitstream. CPB memory 320 and DPB 314 may each be formed by any of a variety of memory devices or memory units, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 15 are illustrated to assist with understanding the operations performed by video decoder 300. The units may be implemented as fixed-function circuits, programmable circuits, or a combination thereof. Similar to FIG. 14, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 14).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 14). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including memory configured to store video data, and one or more processing units implemented in circuitry and configured to adaptively determine a cost function; and decode the video data based on the determined cost function.

Video decoder 300 also represents an example of a video decoding device including memory configured to store video data, and one or more processing units implemented in circuitry and configured to: determine to decode a current block of the video data using an inter mode; determine a value of an index to a prediction candidate in a candidate list; determine the prediction candidate and a first cost function of a plurality of cost functions based on the value of the index; and decode the current block based on the prediction candidate and the first cost function.

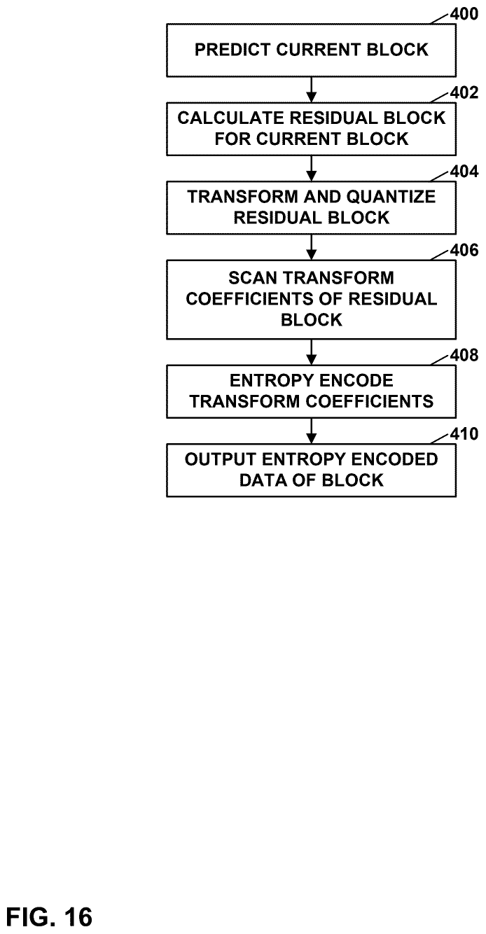

FIG. 16 is a flowchart illustrating an example method for encoding a current block in accordance with the techniques of this disclosure. The current block may be or include a current CU. Although described with respect to video encoder 200 (FIGS. 1 and 14), it should be understood that other devices may be configured to perform a method similar to that of FIG. 16.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

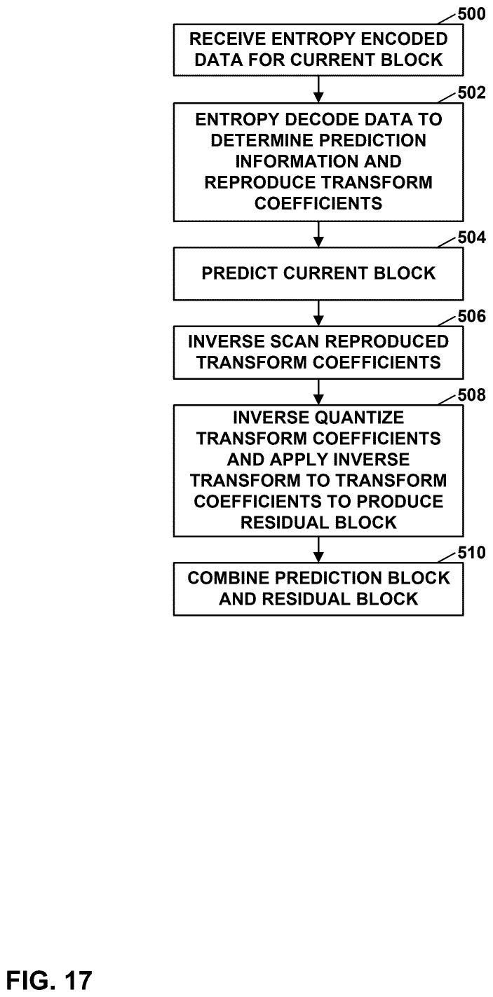

FIG. 17 is a flowchart illustrating an example method for decoding a current block of video data in accordance with the techniques of this disclosure. The current block may be or include a current CU. Although described with respect to video decoder 300 (FIGS. 1 and 15), it should be understood that other devices may be configured to perform a method similar to that of FIG. 17.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients and apply an inverse transform to the transform coefficients to produce a residual block (508). Video decoder 300 may ultimately decode the current block by combining the prediction block and the residual block (510).

The following numbered clauses illustrate one or more aspects of the devices and techniques described in this disclosure.
Aspect 1A. A method of coding video data, the method comprising: adaptively determining a cost function; and coding the video data based on the determined cost function.
Aspect 2A. The method of aspect 1A, wherein coding the video data comprises at least one of refining at least one motion vector based on the determined cost function or reordering motion vector predictors based on the determined cost function.
Aspect 3A. The method of aspect 1A or aspect 2A, wherein the determined cost function comprises a sum of absolute differences (SAD), sum of transformed absolute differences (SATD), sum of squared error (SSE), weighted-SAD, mean-removal (MR)-SAD, MR-SATD, or mean-scaled-SATD.
Aspect 4A. The method of any of aspects 1A-3A, wherein coding the video data comprises coding the video data using an inter prediction mode.
Aspect 5A. The method of any of aspects 1A-4A, wherein the video data comprises a random access (RA) slice, an RA picture, a low delay B (LDB) slice, an LDB picture, a low delay P (LDP) slice, or an LDP picture.
Aspect 6A. The method of any of aspects 1A-5A, wherein adaptively determining the cost function comprises determining the cost function based on a candidate index.
Aspect 7A. The method of aspect 6A, wherein coding the video data comprises applying the determined cost function to at least one candidate of a candidate list.
Aspect 8A. The method of any of aspects 6A-7A, wherein the candidate index is either an odd number or an even number, wherein determining the cost function based on the candidate index comprises determining whether the candidate index is an odd number or an even number, the odd number being indicative of a first cost function and the even number being indicative of a second cost function.
Aspect 9A. The method of any of aspects 6A-7A, wherein adaptively determining the cost function comprises: determining a plurality of subgroups of candidates in a candidate list; and determining the cost function based on plurality of subgroups.
Aspect 10A. The method of any of aspects 6A-7A, wherein adaptively determining the cost function is based on a mapping table, the mapping table mapping respective merge indexes to corresponding cost functions.
Aspect 11A. The method of any of aspects 6A-7A, wherein adaptively determining the cost function comprises: applying a plurality of cost functions to a first candidate; appending a candidate list with resulting candidates of the application of the plurality of cost functions to generate an appended candidate list; and sorting the appended candidate list.
Aspect 12A. The method of any of aspects 1A-5A, wherein adaptively determining the cost function comprises adaptively determining the cost function based on a block size.
Aspect 13A. The method of aspect 12A, wherein coding the video data comprises applying the determined cost function during a motion vector predictor reordering and during a motion vector refinement.
Aspect 14A. The method of any of aspects 1A-5A, wherein adaptively determining the cost function comprises adaptively determining the cost function based on a prediction mode.
Aspect 15A. The method of aspect 14A, wherein coding the video data comprises applying the determined cost function during a motion vector predictor reordering and during a motion vector refinement.
Aspect 16A. The method of any of aspects 1A-5A, wherein adaptively determining the cost function comprises parsing a flag in a bitstream indicative of the determined cost function.
Aspect 17A. The method of any of aspects 1A-5A, wherein adaptively determining the cost function comprises determining a cost function having a best rate-distortion performance from a group of cost functions.
Aspect 18A. The method of any of aspects 1A-16A, wherein coding comprises decoding.
Aspect 19A. The method of any of aspects 1-15A, or 17A, wherein coding comprises encoding.
Aspect 20A. A device for coding video data, the device comprising one or more means for performing the method of any of aspects 1A-19A.
Aspect 21A. The device of aspect 20A, wherein the one or more means comprise one or more processors implemented in circuitry.
Aspect 22A. The device of any of aspects 20A or 21A, further comprising a memory to store the video data.
Aspect 23A. The device of any of aspects 20A-22A, further comprising a display configured to display decoded video data.
Aspect 24A. The device of any of aspects 20A-23A, wherein the device comprises one or more of a camera, a computer, a mobile device, a broadcast receiver device, or a set-top box.
Aspect 25A. The device of any of aspects 20A-24A, wherein the device comprises a video decoder.
Aspect 26A. The device of any of aspects 20A-25A, wherein the device comprises a video encoder.
Aspect 27A. A computer-readable storage medium having stored thereon instructions that, when executed, cause one or more processors to perform the method of any of aspects 1A-19A.
Aspect 1B. A method of decoding video data, the method comprising: determining to decode a current block of the video data using an inter mode; determining a value of an index to a prediction candidate in a candidate list; determining the prediction candidate and a first cost function of a plurality of cost functions based on the value of the index; and decoding the current block based on the prediction candidate and the first cost function.
Aspect 2B. The method of aspect 1B, wherein the first cost function is determined based on selecting between the first cost function and a second cost function based on a parity of the value of the index, the first cost function being selected if the value of the index is odd and the second cost function being selected if the value of the index is even.
Aspect 3B. The method of aspect 1B or aspect 2B, wherein decoding the current block comprises refining at least one motion vector associated with the prediction candidate based on the first cost function.
Aspect 4B. The method of any of aspects 1B-3B, wherein decoding the current block comprises reordering motion vector predictors in motion vector predictor list based on the first cost function.
Aspect 5B. The method of any of aspects 1B-4B, wherein the inter mode comprises a regular merge mode, a template matching merge mode, a bilateral matching merge mode, a geometric partitioning merge mode, an AMVP-merge mode, or an affine mode.
Aspect 6B. The method of aspect 5B, wherein determining the first cost function is further based on a type of the inter mode.
Aspect 7B. The method of any of aspects 1B-6B, wherein decoding the current block comprises applying the first cost function for at least one candidate of the candidate list.
Aspect 8B. The method of any of aspects 1B-7B, wherein the first cost function comprises a sum of absolute differences (SAD), a sum of transformed absolute differences (SATD), a sum of squared error (SSE), a weighted-SAD, a mean-removal (MR)-SAD, a MR-SATD, or a mean-scaled-SATD.
Aspect 9B. The method of any of aspects 1B-8B, wherein the current block comprises a block of a random access (RA) slice, an RA picture, a low delay B (LDB) slice, an LDB picture, a low delay P (LDP) slice, or an LDP picture.
Aspect 10B. The method of any of aspects 1B-9B, wherein determining the first cost function comprises: determining a plurality of subgroups of candidates in the candidate list, each subgroup of the plurality of subgroups having a number of candidates equal to a number of cost functions of the plurality of cost functions; and determining that the value of the index is associated with a first candidate in one subgroup of the plurality of subgroups, the first candidate of each subgroup of the plurality of subgroups being associated with the first cost function.
Aspect 11B. The method of aspect 1B, wherein determining the first cost function comprises looking up the value of the index in a mapping table, the mapping table mapping respective merge indexes to corresponding cost functions of the plurality of cost functions.
Aspect 12B. The method of any of aspects 1B-11B, wherein the first cost function is further determined based on selecting between the first cost function and a second cost function based on a block size of the current block, the first cost function being selected if the block size of the current block is a first size and the second cost function being selected if the value of the index is a second size.
Aspect 13B. The method of any of aspects 1B-12B, wherein the current block comprises a current subblock.
Aspect 14B. The method of any of aspects 1B-13B, wherein the prediction candidate is a first prediction candidate, wherein the candidate list is a first candidate list, wherein the first prediction candidate is in a first portion of the first candidate list, and wherein the current block is a first current block, the method further comprising: determining to code a second current block of the video data using the inter mode; determining a value of an index to a second prediction candidate in a second candidate list; determining that the second prediction candidate is in a second portion of the second candidate list; determining, based on the second prediction candidate being in the second portion of the second candidate list, a second cost function; and decoding the current block based on the second cost function.
Aspect 15B. A device for decoding video data, the device comprising: one or more memories configured to store the video data; and one or more processors implemented in circuitry and operably coupled to the one or more memories, the one or more processors configured to: determine to decode a current block of the video data using an inter mode; determine a value of an index to a prediction candidate in a candidate list; determine the prediction candidate and a first cost function of a plurality of cost functions based on the value of the index; and decode the current block based on the prediction candidate and the first cost function.
Aspect 16B. The device of aspect 15B, wherein the first cost function is determined based on selecting between the first cost function and a second cost function based on a parity of the value of the index, the first cost function being selected if the value of the index is odd and the second cost function being selected if the value of the index is even.
Aspect 17B. The device of aspect 15B or aspect 16B, wherein as part of decoding the current block, the one or more processors are configured to refine at least one motion vector associated with the prediction candidate based on the first cost function.
Aspect 18B. The device of any of aspects 15B-17B, wherein as part of decoding the current block, the one or more processors are configured to reorder motion vector predictors in motion vector predictor list based on the first cost function.
Aspect 19B. The device of any of aspects 15B-18B, wherein the inter mode comprises a regular merge mode, a template matching merge mode, a bilateral matching merge mode, a geometric partitioning merge mode, an AMVP-merge mode, or an affine mode.
Aspect 20B. The device of aspect 19B, wherein the one or more processors are configured to determine the first cost function further based on a type of the inter mode.
Aspect 21B. The device of any of aspects 15B-20B, wherein as part of decoding the current block, the one or more processors are configured to apply the first cost function for at least one candidate of the candidate list.
Aspect 22B. The device of any of aspects 15B-21B, wherein the first cost function comprises a sum of absolute differences (SAD), a sum of transformed absolute differences (SATD), a sum of squared error (SSE), a weighted-SAD, a mean-removal (MR)-SAD, a MR-SATD, or a mean-scaled-SATD.
Aspect 23B. The device of any of aspects 15B-22B, wherein the current block comprises a block of a random access (RA) slice, an RA picture, a low delay B (LDB) slice, an LDB picture, a low delay P (LDP) slice, or an LDP picture.
Aspect 24B. The device of any of aspects 15B-23B, wherein as part of determining the first cost function, the one or more processors are configured to: determine a plurality of subgroups of candidates in the candidate list, each subgroup of the plurality of subgroups having a number of candidates equal to a number of cost functions of the plurality of cost functions; and determine that the value of the index is associated with a first candidate in one subgroup of the plurality of subgroups, the first candidate of each subgroup of the plurality of subgroups being associated with the first cost function.
Aspect 25B. The device of any of aspects 15B-24B, wherein as part of determining the first cost function, the one or more processors are configured to look up the value of the index in a mapping table, the mapping table mapping respective merge indexes to corresponding cost functions of the plurality of cost functions.
Aspect 26B. The device of any of aspects 15B-25B, wherein the first cost function is further determined based on selecting between the first cost function and a second cost function based on a block size of the current block, the first cost function being selected if the block size of the current block is a first size and the second cost function being selected if the value of the index is a second size.
Aspect 27B. The device of any of aspects 15B-26B, wherein the current block comprises a current subblock.
Aspect 28B. The device of any of aspects 15B-27B, wherein the prediction candidate is a first prediction candidate, wherein the candidate list is a first candidate list, wherein the first prediction candidate is in a first portion of the first candidate list, wherein the current block is a first current block, and wherein the one or more processors are further configured to: determine to code a second current block of the video data using the inter mode; determine a value of an index to a second prediction candidate in a second candidate list; determine that the second prediction candidate is in a second portion of the second candidate list; determine, based on the second prediction candidate being in the second portion of the second candidate list, a second cost function; and decode the current block based on the second cost function.
Aspect 29B. The device of any of aspects 15B-28B, further comprising a display configured to display decoded video data.
Aspect 30B. A method of encoding video data, the method comprising: determining to encode a current block of the video data using an inter mode; determining a value of an index to a prediction candidate in a candidate list; determining the prediction candidate and a first cost function of a plurality of cost functions based on the value of the index; and encoding the current block in accordance with the prediction candidate and the first cost function.
Aspect 31B. Computer-readable storage media storing instructions which, when executed, cause one or more processors to: determine to decode a current block of video data using an inter mode; determine a value of an index to a prediction candidate in a candidate list; determine the prediction candidate and a first cost function of a plurality of cost functions based on the value of the index; and decode the current block based on the prediction candidate and the first cost function.
Aspect 32B. A device for decoding video data, the device comprising: means for determining to decode a current block of the video data using an inter mode; means for determining a value of an index to a prediction candidate in a candidate list; means for determining the prediction candidate and a first cost function of a plurality of cost functions based on the value of the index; and means for decoding the current block based on the prediction candidate and the first cost function.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of decoding video data, the method comprising:
determining to decode a current block of the video data using an inter mode;
determining a value of an index to a prediction candidate in a candidate list;
determining the prediction candidate and a first cost function of a plurality of cost functions based on the value of the index; and
decoding the current block based on the prediction candidate and the first cost function.

2. The method of claim 1, wherein the first cost function is determined based on selecting between the first cost function and a second cost function based on a parity of the value of the index, the first cost function being selected if the value of the index is odd and the second cost function being selected if the value of the index is even.

3. The method of claim 1, wherein decoding the current block comprises refining at least one motion vector associated with the prediction candidate based on the first cost function.

4. The method of claim 1, wherein decoding the current block comprises reordering motion vector predictors in motion vector predictor list based on the first cost function.

5. The method of claim 1, wherein the inter mode comprises a regular merge mode, a template matching merge mode, a bilateral matching merge mode, a geometric partitioning merge mode, an AMVP-merge mode, or an affine mode.

6. The method of claim 5, wherein determining the first cost function is further based on a type of the inter mode.

7. The method of claim 1, wherein decoding the current block comprises applying the first cost function for at least one candidate of the candidate list.

8. The method of claim 1, wherein the first cost function comprises a sum of absolute differences (SAD), a sum of transformed absolute differences (SATD), a sum of squared error (SSE), a weighted-SAD, a mean-removal (MR)-SAD, a MR-SATD, or a mean-scaled-SATD.

9. The method of claim 1, wherein the current block comprises a block of a random access (RA) slice, an RA picture, a low delay B (LDB) slice, an LDB picture, a low delay P (LDP) slice, or an LDP picture.

10. The method of claim 1, wherein determining the first cost function comprises:
determining a plurality of subgroups of candidates in the candidate list, each subgroup of the plurality of subgroups having a number of candidates equal to a number of cost functions of the plurality of cost functions; and
determining that the value of the index is associated with a first candidate in one subgroup of the plurality of subgroups, the first candidate of each subgroup of the plurality of subgroups being associated with the first cost function.

11. The method of claim 1, wherein determining the first cost function comprises looking up the value of the index in a mapping table, the mapping table mapping respective merge indexes to corresponding cost functions of the plurality of cost functions.

12. The method of claim 1, wherein the first cost function is further determined based on selecting between the first cost function and a second cost function based on a block size of the current block, the first cost function being selected if the block size of the current block is a first size and the second cost function being selected if the value of the index is a second size.

13. The method of claim 1, wherein the current block comprises a current subblock.

14. The method of claim 1, wherein the prediction candidate is a first prediction candidate, wherein the candidate list is a first candidate list, wherein the first prediction candidate is in a first portion of the first candidate list, and wherein the current block is a first current block, the method further comprising:
determining to code a second current block of the video data using the inter mode;
determining a value of an index to a second prediction candidate in a second candidate list;
determining that the second prediction candidate is in a second portion of the second candidate list;
determining, based on the second prediction candidate being in the second portion of the second candidate list, a second cost function; and
decoding the current block based on the second cost function.

15. A device for decoding video data, the device comprising:
one or more memories configured to store the video data; and
one or more processors implemented in circuitry and operably coupled to the one or more memories, the one or more processors configured to:
determine to decode a current block of the video data using an inter mode;
determine a value of an index to a prediction candidate in a candidate list;
determine the prediction candidate and a first cost function of a plurality of cost functions based on the value of the index; and
decode the current block based on the prediction candidate and the first cost function.

16. The device of claim 15, wherein the first cost function is determined based on selecting between the first cost function and a second cost function based on a parity of the value of the index, the first cost function being selected if the value of the index is odd and the second cost function being selected if the value of the index is even.

17. The device of claim 15, wherein as part of decoding the current block, the one or more processors are configured to refine at least one motion vector associated with the prediction candidate based on the first cost function.

18. The device of claim 15, wherein as part of decoding the current block, the one or more processors are configured to reorder motion vector predictors in motion vector predictor list based on the first cost function.

19. The device of claim 15, wherein the inter mode comprises a regular merge mode, a template matching merge mode, a bilateral matching merge mode, a geometric partitioning merge mode, an AMVP-merge mode, or an affine mode.

20. The device of claim 19, wherein the one or more processors are configured to determine the first cost function further based on a type of the inter mode.

21. The device of claim 15, wherein as part of decoding the current block, the one or more processors are configured to apply the first cost function for at least one candidate of the candidate list.

22. The device of claim 15, wherein the first cost function comprises a sum of absolute differences (SAD), a sum of transformed absolute differences (SATD), a sum of squared error (SSE), a weighted-SAD, a mean-removal (MR)-SAD, a MR-SATD, or a mean-scaled-SATD.

23. The device of claim 15, wherein the current block comprises a block of a random access (RA) slice, an RA picture, a low delay B (LDB) slice, an LDB picture, a low delay P (LDP) slice, or an LDP picture.

24. The device of claim 15, wherein as part of determining the first cost function, the one or more processors are configured to:
determine a plurality of subgroups of candidates in the candidate list, each subgroup of the plurality of subgroups having a number of candidates equal to a number of cost functions of the plurality of cost functions; and
determine that the value of the index is associated with a first candidate in one subgroup of the plurality of subgroups, the first candidate of each subgroup of the plurality of subgroups being associated with the first cost function.

25. The device of claim 15, wherein as part of determining the first cost function, the one or more processors are configured to look up the value of the index in a mapping table, the mapping table mapping respective merge indexes to corresponding cost functions of the plurality of cost functions.

26. The device of claim 15, wherein the first cost function is further determined based on selecting between the first cost function and a second cost function based on a block size of the current block, the first cost function being selected if the block size of the current block is a first size and the second cost function being selected if the value of the index is a second size.

27. The device of claim 15, wherein the current block comprises a current subblock.

28. The device of claim 15, wherein the prediction candidate is a first prediction candidate, wherein the candidate list is a first candidate list, wherein the first prediction candidate is in a first portion of the first candidate list, wherein the current block is a first current block, and wherein the one or more processors are further configured to:
determine to code a second current block of the video data using the inter mode;
determine a value of an index to a second prediction candidate in a second candidate list;
determine that the second prediction candidate is in a second portion of the second candidate list;
determine, based on the second prediction candidate being in the second portion of the second candidate list, a second cost function; and
decode the current block based on the second cost function.

29. The device of claim 15, further comprising a display configured to display decoded video data.

30. A method of encoding video data, the method comprising:
determining to encode a current block of the video data using an inter mode;
determining a value of an index to a prediction candidate in a candidate list;
determining the prediction candidate and a first cost function of a plurality of cost functions based on the value of the index; and
encoding the current block in accordance with the prediction candidate and the first cost function.

31. A device for decoding video data, the device comprising:
means for determining to decode a current block of the video data using an inter mode;
means for determining a value of an index to a prediction candidate in a candidate list;
means for determining the prediction candidate and a first cost function of a plurality of cost functions based on the value of the index; and
means for decoding the current block based on the prediction candidate and the first cost function.
